(19) United States
(12) Patent Application Publication
(10) Pub. No.: US 2025/0354683 A1
(43) Pub. Date: Nov. 20, 2025

(54) LIGHT SOURCE DEVICE AND COOLING UNIT

(71) Applicant: OLYMPUS MEDICAL SYSTEMS CORP., Tokyo (JP)

(72) Inventors: Toru KUBOI, Tokyo (JP); Rihito ISHIKAWA, Tokyo (JP)

(73) Assignee: OLYMPUS MEDICAL SYSTEMS CORP., Tokyo (JP)

(21) Appl. No.: 19/289,308

(22) Filed: Aug. 4, 2025

Related U.S. Application Data
(63) Continuation of application No. PCT/JP2023/004065, filed on Feb. 7, 2023.

(51) Int. Cl. F21V 29/60; F21Y 113/13

(52) U.S. Cl. CPC F21V 29/60; F21Y 2113/13

(57) ABSTRACT

A light source device includes: a first light emitting element having a maximum junction temperature at a first temperature; a second light emitting element having a maximum junction temperature at a second temperature higher than the first temperature; a third light emitting element having a maximum junction temperature at a third temperature equal to or higher than the second temperature; a first heat sink to which the first light emitting element is thermally connected; and a second heat sink to which the third light emitting element is thermally connected.

### CROSS REFERENCES TO RELATED APPLICATIONS

This application is a continuation of International Application No. PCT/JP2023/004065, filed on Feb. 7, 2023, the entire contents of which are incorporated herein by reference.

### BACKGROUND

### 1. Technical Field

The present disclosure relates to a light source device and a cooling unit.

### 2. Related Art

In the related art, a light source device including plural light emitting elements has been known (see, for example, Japanese Unexamined Patent Application, Publication No. 2008-158191).

Plural light emitting elements are thermally connected to the same heat sink for the plural light emitting elements to be cooled collectively in a light source device described in Japanese Unexamined Patent Application, Publication No. 2008-158191.

### SUMMARY

In some embodiments, a light source device includes: a first light emitting element having a maximum junction temperature at a first temperature; a second light emitting element having a maximum junction temperature at a second temperature higher than the first temperature; a third light emitting element having a maximum junction temperature at a third temperature equal to or higher than the second temperature; a first heat sink to which the first light emitting element is thermally connected; and a second heat sink to which the third light emitting element is thermally connected. The second light emitting element is thermally connected to a heat sink shared with a light emitting element that is one of the first light emitting element and the third light emitting element and that forms a combination with the second light emitting element resulting in a larger allowable heat resistance of a radiator, the allowable heat resistance being calculated from: a difference between a maximum junction temperature and an ambient temperature; and an amount of heat generated.

In some embodiments, a cooling unit includes: a first heat generating element having a maximum junction temperature at a first temperature; a second heat generating element having a maximum junction temperature at a second temperature higher than the first temperature; a third heat generating element having a maximum junction temperature at a third temperature equal to or higher than the second temperature; a first heat sink to which the first heat generating element is thermally connected; and a second heat sink to which the third heat generating element is thermally connected. The second heat generating element is thermally connected to a heat sink shared with a heat generating element that is one of the first heat generating element and the third heat generating element and that forms a combination with the second heat generating element resulting in a larger allowable heat resistance of a radiator, the allowable heat resistance being calculated from: a difference between a maximum junction temperature and an ambient temperature; and an amount of heat generated.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a diagram illustrating a configuration of an endoscope system according to a first embodiment;

FIG. 2 is a diagram illustrating a configuration of a light source device;

FIG. 3 is a diagram illustrating a modified example 1-1 of the first embodiment;

FIG. 4 is a diagram illustrating a modified example 1-3 of the first embodiment;

FIG. 5 is a diagram illustrating a configuration of a light source device according to a second embodiment;

FIG. 6 is a diagram illustrating a modified example 2-1 of the second embodiment;

FIG. 7 is a diagram illustrating a modified example 2-2 of the second embodiment;

FIG. 8 is a diagram illustrating a modified example 2-3 of the second embodiment;

FIGS. 9A to 9D are diagrams for description of the modified example 2-3 of the second embodiment;

FIG. 10 is a diagram for description of the modified example 2-3 of the second embodiment;

FIG. 11 is a diagram for description of the modified example 2-3 of the second embodiment; and

FIG. 12 is a diagram for description of the modified example 2-3 of the second embodiment.

### DETAILED DESCRIPTION

Modes for implementing the disclosure (hereinafter, embodiments) will be described hereinafter while reference is made to the drawings. The disclosure is not to be limited by the embodiments described hereinafter. Like portions will be assigned with like reference signs, throughout the drawings.

### First Embodiment

### Configuration of Endoscope System

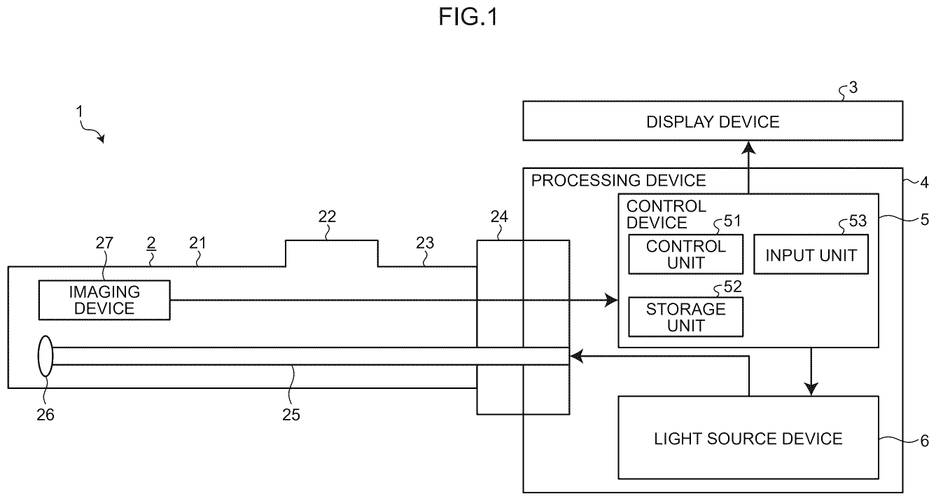

FIG. 1 is a diagram illustrating a configuration of an endoscope system 1 according to a first embodiment.

The endoscope system 1 is a system that is used in the medical field and that is for observation of the interior (inside a living body) of a subject. This endoscope system 1 includes, as illustrated in FIG. 1, an endoscope 2, a display device 3, and a processing device 4.

In this first embodiment, the endoscope 2 is a so-called flexible endoscope. Part of the endoscope 2 is inserted into a living body, and the endoscope 2 images the interior of the living body and outputs an image signal generated by this imaging. The endoscope 2 includes, as illustrated in FIG. 1, an insertion unit 21, an operating unit 22, a universal cord 23, and a connector unit 24.

At least part of the insertion unit 21 has flexibility and the insertion unit 21 is a portion to be inserted in the living body. A light guide 25, an illumination lens 26, and an imaging device 27 have been provided in this insertion unit 21, as illustrated in FIG. 1.

The light guide 25 is laid from the insertion unit 21 to the connector unit 24 through the operating unit 22 and the universal cord 23. On end of the light guide 25 is positioned in a distal end portion of the insertion unit 21. In a state where the endoscope 2 has been connected to the processing device 4, the other end of the light guide 25 is positioned in the processing device 4. The light guide 25 transmits light supplied from a light source device 6 in the processing device 4 from the other end to the one end of the light guide 25.

The illumination lens 26 is opposed to the one end of the light guide 25 in the insertion unit 21. The light transmitted by the light guide 25 is emitted to the interior of the living body through the illumination lens 26.

The imaging device 27 is provided in the distal end portion of the insertion unit 21. The imaging device 27 has an imaging element, such as a charge coupled device (CCD) or a complementary metal oxide semiconductor (CMOS), which optically receives a subject image from the interior of the living body and converts the subject image into an electric signal, and the imaging device 27 outputs an image signal generated by this imaging.

The operating unit 22 is connected to a proximal end portion of the insertion unit 21. The operating unit 22 receives various kinds of operation for the endoscope 2.

The universal cord 23 is a cord that extends from the operating unit 22, in a direction different from a direction, in which the insertion unit 21 extends, and the cord has, provided therein, for example, the light guide 25 and a signal line electrically connected to the imaging device 27 and a control device 5 in the processing device 4.

The connector unit 24 is provided at an end portion of the universal cord 23 and is detachably connected to the processing device 4.

The display device 3 is, for example, a display, such as a liquid crystal display (LCD) or an electroluminescence (EL) display, and displays, for example, an image that has been subjected to image processing by the processing device 4.

The processing device 4 includes, as illustrated in FIG. 1, the control device 5, and the light source device 6. In this embodiment, the light source device 6 and the control device 5 are provided in a single housing as the processing device 4, but without being limited to this embodiment, the light source device 6 and the control device 5 may be provided respectively in separate housings.

The light source device 6 corresponds to a cooling unit. Under control by the control device 5, the light source device 6 supplies illumination light to the other end of the light guide 25.

A detailed configuration of the light source device 6 will be described in a section, “Configuration of Light Source Device”, later.

The control device 5 integrally controls overall operation of the endoscope system 1. As illustrated in FIG. 1, the control device 5 includes a control unit 51, a storage unit 52, and an input unit 53.

The control unit 51 is configured to include a controller, such as a central processing unit (CPU) or a microprocessing unit (MPU), or an integrated circuit, such as an application specific integrated circuit (ASIC) or a field programmable gate array (FPGA), and controls the overall operation of the endoscope system 1.

The storage unit 52 stores various programs executed by the control unit 51 and information needed in processing by the control unit 51, for example.

The input unit 53 is configured using a keyboard, a mouse, a switch, and/or a touch panel, for example, and receives user operation by a user, such as an operating surgeon. The input unit 53 outputs an operation signal corresponding to the user operation, to the control unit 51.

### Configuration of Light Source Device

A configuration of the light source device 6 will be described next.

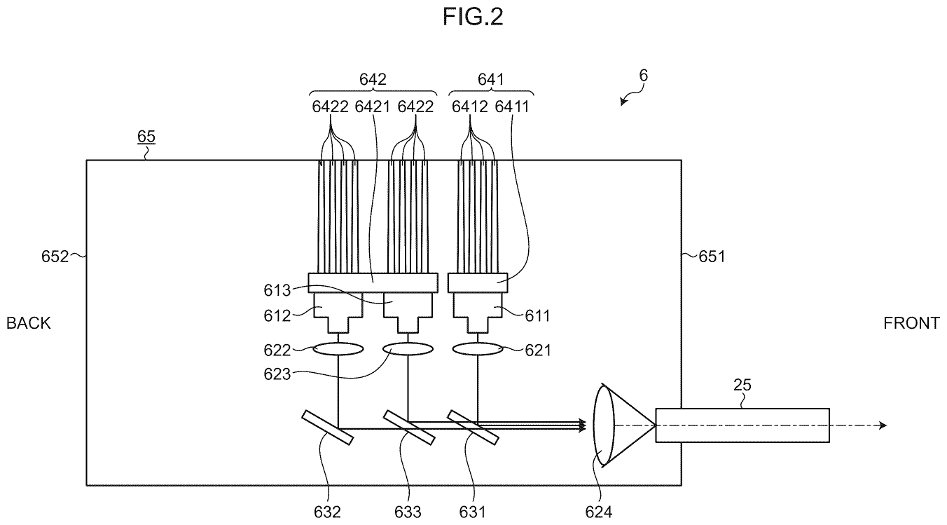

FIG. 2 is a diagram illustrating the configuration of the light source device 6.

The light source device 6 includes, as illustrated in FIG. 2, red, blue, and green light sources 611 to 613, first to fourth lenses 621 to 624, first to third dichroic mirrors 631 to 633, first and second heat sinks 641 and 642, and a housing 65 where these members 611 to 613, 621 to 624, 631 to 633, 641, and 642 are housed in.

The red light source 611 includes a light emitting diode (LED) or a laser diode (LD) and emits red light (for example, light in a wavelength band of about 600 to 700 nm). This red light source 611 corresponds to a first light emitting element and a first heat generating element, and has a maximum junction temperature at a first temperature.

The blue light source 612 includes an LED or LD and emits blue light (for example, light in a wavelength band of about 430 to 490 nm). This blue light source 612 corresponds to a second light emitting element and a second heat generating element, and has a maximum junction temperature at a second temperature higher than the first temperature.

The green light source 613 includes an LED or LD and emits green light (for example, light in a wavelength band of about 490 to 550 nm). This green light source 613 corresponds to a third light emitting element and a third heat generating element, and has a maximum junction temperature at a third temperature equal to or higher than the second temperature.

The first to third dichroic mirrors 631 to 633 bend light from the red, blue, and green light sources 611 to 613 to let the light travel on the same optical axis.

Specifically, the first dichroic mirror 631 bends the red light emitted from the red light source 611 and condensed by the first lens 621 and transmits light in any other wavelength band therethrough, the light being other than the red light.

The second dichroic mirror 632 bends the blue light emitted from the blue light source 612 and condensed by the second lens 622 and transmits light in any other wavelength band therethrough, the light being other than the blue light.

The third dichroic mirror 633 bends the green light emitted from the green light source 613 and condensed by the third lens 623 and transmits light in any other wavelength band therethrough, the light being other than the green light.

The fourth lens 624 condenses illumination light (white light) that is a combination of the above mentioned red light, blue light, and green light coming via the first to third dichroic mirrors 631 to 633 and guides the condensed illumination light to the other end of the light guide 25.

A side wall 651 (FIG. 2) of the housing 65 is a front side wall where, for example, a medical doctor who operates the endoscope 2 is present, the side wall 651 being at an end where the other end of the light guide 25 is connected. A side wall 652 (FIG. 2) opposite to the side wall 651 is a back side wall.

The first and second heat sinks 641 and 642 radiate heat generated in the red, blue, and green light sources 611 to 613, into the atmosphere.

Specifically, the first heat sink 641 includes, as illustrated in FIG. 2: a heat receiver 6411 that at least the red light source 611 is thermally connected to and that receives at least the heat generated in the red light source 611; and plural fins 6412 that radiate heat from the heat receiver 6411 into the atmosphere.

The second heat sink 642 includes, as illustrated in FIG. 2: a heat receiver 6421 that at least the green light source 613 is thermally connected to and that receives at least the heat generated in the green light source 613; and plural fins 6422 that radiate heat from the heat receiver 6421 into the atmosphere.

Connective relations between the first and second heat sinks 641 and 642 and the blue light source 612 will be described in a section, “Connective Relations Between First and Second Heat Sinks and Blue Light Source”, later.

### Connective Relations Between First and Second Heat Sinks and Blue Light Source

The connective relations between the first and second heat sinks 641 and 642 and the blue light source 612 will be described next.

In thermally connecting the blue light source 612 to one of the first and second heat sinks 641 and 642, inventors of the present application took maximum junction temperatures of the red, blue, and green light sources 611 to 613 into consideration.

Table 1 below corresponds to a case where the red, blue, and green light sources 611 to 613 are thermally connected to the same heat sink.

As listed in Table 1, the maximum junction temperature of the red light source 611 is 90° C. (first temperature). The maximum junction temperature of the blue light source 612 is 125° C. (second temperature). The maximum junction temperature of the green light source 613 is 130° C. (third temperature).

In Table 1, “Ta (° C.)” is a surrounding environmental temperature. Furthermore, “ΔT (° C.)” is a difference between a maximum junction temperature and the surrounding environmental temperature and is thus a difference between: the maximum junction temperature that is the lowest one of those of the heat generating elements thermally connected to the heat sink; and the surrounding environmental temperature. In the case of Table 1, there is one heat sink, and “ΔT (° C.)” is thus a difference between the first temperature (90° C.), which is the lowest one of the maximum junction temperatures, and the surrounding environmental temperature (25° C.). “Amount of heat generated (W)” is the amount of heat generated by the red, blue, and green light sources 611 to 613 and is thus the overall amount of heat generated by the heat generating elements thermally connected to the heat sink. In the case of Table 1, there is one heat sink and the amount of heat generated (W) is thus the overall amount of heat generated by the red, blue, and green light sources 611 to 613. The amount of heat generated by the red light source 611 is 20 W. The amount of heat generated by the blue light source 612 is 10 W. The amount of heat generated by the green light source 613 is 30 W. “Allowable heat resistance (K/W)” is a value resulting from division of ΔT (° C.) by the amount of heat generated (W). “Radiator volume (cc)” is the volume of the heat sink, it is assumed that the radiator volume is 1000 cc in a case where the allowable heat resistance (K/W) is 1, and a value resulting from division of this 1000 cc by a corresponding allowable heat resistance (K/W) is adopted. That is, in the case of Table 1, the radiator volume (cc) is 923 cc resulting from division of 1000 cc by 1.08, which is the allowable heat resistance (K/W).

TABLE 1

Red, green, and blue

| | | | |
|---|---|---|---|
| Maximum junction temperature (° C.) | 90 | 130 | 125 |

| | |
|---|---|
| Ta (° C.) | 25 |
| ΔT (° C.) | 65 |
| Amount of heat generated (W) | 60 |
| Allowable heat resistance (K/W) | 1.08 |
| Radiator volume (cc) | 923 |

Table 2 below corresponds to a case where the red light source 611 is thermally connected to the first heat sink 641 and the blue and green light sources 612 and 613 are thermally connected to the second heat sink 642.

The maximum junction temperatures (° C.), Ta (° C.) and the amounts of heat generated (W) listed in Table 2 are the same as those listed in Table 1. Furthermore, ΔT (C), the allowable heat resistances (K/W), and the radiator volumes (cc) listed in Table 2 are calculated by methods similar to those listed in Table 1.

TABLE 2

| | Red | Green and blue | |
|---|---|---|---|
| Maximum junction temperature (° C.) | 90 | 130 | 125 |

| Ta (° C.) | 25 | |
|---|---|---|
| ΔT (° C.) | 65 | 100 |
| Amount of heat generated (W) | 20 | 40 |
| Allowable heat resistance (K/W) | 3.25 | 2.50 |
| Radiator volume (cc) | 308 | 400 |

Table 3 below corresponds to a case where the red and green light sources 611 and 613 are thermally connected to the same heat sink and the blue light source 612 is thermally connected to another heat sink.

The maximum junction temperatures (° C.), Ta (° C.) and the amounts of heat generated (W) listed in Table 3 are the same as those listed in Table 1. Furthermore, ΔT (° C.), the allowable heat resistances (K/W), and the radiator volumes (cc) listed in Table 3 are calculated by methods similar to those listed in Table 1.

TABLE 3

| | Red and green | | Blue |
|---|---|---|---|
| Maximum junction temperature (° C.) | 90 | 130 | 125 |

| Ta (° C.) | 25 | |
|---|---|---|
| ΔT (C) | 65 | 100 |
| Amount of heat generated (W) | 50 | 10 |
| Allowable heat resistance (K/W) | 1.30 | 10 |
| Radiator volume (cc) | 769 | 100 |

Table 4 below corresponds to a case where the red and blue light sources 611 and 612 are thermally connected to the first heat sink 641 and the green light source 613 is thermally connected to the second heat sink 642.

The maximum junction temperatures (° C.), Ta (° C.), and the amounts of heat generated (W) listed in Table 4 are the same as those listed in Table 1. Furthermore, ΔT (° C.), the allowable heat resistances (K/W), and the radiator volumes (cc) listed in Table 4 are calculated by methods similar to those listed in Table 1.

TABLE 4

| | Red and blue | | Green |
|---|---|---|---|
| Maximum junction temperature (° C.) | 90 | 125 | 130 |

| Ta (° C.) | 25 | |
|---|---|---|
| ΔT (° C.) | 65 | 105 |
| Amount of heat generated (W) | 30 | 30 |
| Allowable heat resistance (K/W) | 2.17 | 3.50 |
| Radiator volume (cc) | 462 | 286 |

The radiator volume (cc) of the heat sink, 923 cc (Table 1), in the case where the red, blue, and green light sources 611 to 613 are thermally connected to the same heat sink is regarded herein as 100%. By contrast, the overall radiator volume (cc) of the first and second heat sinks 641 and 642 in the case where the red light source 611 is thermally connected to the first heat sink 641 and the blue and green light sources 612 and 613 are thermally connected to the second heat sink 642 is 708 cc (Table 2), which is 77%. Furthermore, the overall radiator volume (cc) of the heat sinks in the case where the red and green light sources 611 and 613 are thermally connected to the same heat sink and the blue light source 612 is thermally connected to another heat sink is 869 cc (Table 3), which is 94%. The overall radiator volume (cc) of the first and second heat sinks 641 and 642 in the case where the red and blue light sources 611 and 612 are thermally connected to the first heat sink 641 and the green light source 613 is thermally connected to the second heat sink 642 is 747 cc (Table 4), which is 81%.

In view of the above, the inventors of the present application thermally connected the red light source 611 to the first heat sink 641 and thermally connected the blue and green light sources 612 and 613 to the second heat sink 642, as illustrated in FIG. 2, so as to minimize the radiator volume (cc). In other words, the blue light source 612 is thermally connected to the second heat sink 642 shared with the green light source 613 that is one of the red and green light sources 611 and 613, the one having the maximum junction temperature (third temperature) with a smaller difference from the second temperature.

The first embodiment described above has the following effects.

In the light source device 6 according to the first embodiment, the red light source 611 is thermally connected to the first heat sink 641. The blue and green light sources 612 and 613 are thermally connected to the second heat sink 642. More specifically, the blue light source 612 is thermally connected to the second heat sink 642 shared with the green light source 613 that is one of the red and green light sources 611 and 613, the one having the maximum junction temperature with a smaller difference from the maximum junction temperature of the blue light source 612.

Therefore, as compared to the configuration having the red, blue, and green light sources 611 to 613 thermally connected to the same heat sink, the overall size of the heat sinks is able to be downsized and the light source device 6 is thereby able to be downsized. Furthermore, as compared to the configuration having the red, blue, and green light sources 611 to 613 thermally connected respectively to heat sinks different from one another, for example, the work for positioning the red, blue, and green light sources 611 to 613 relatively to the first and second heat sinks 641 and 642 is facilitated and the cost of manufacturing of the light source device 6 is thus able to be reduced.

Therefore, the light source device 6 according to the first embodiment enables reduction in the manufacturing cost and downsizing.

### Modified Example 1-1

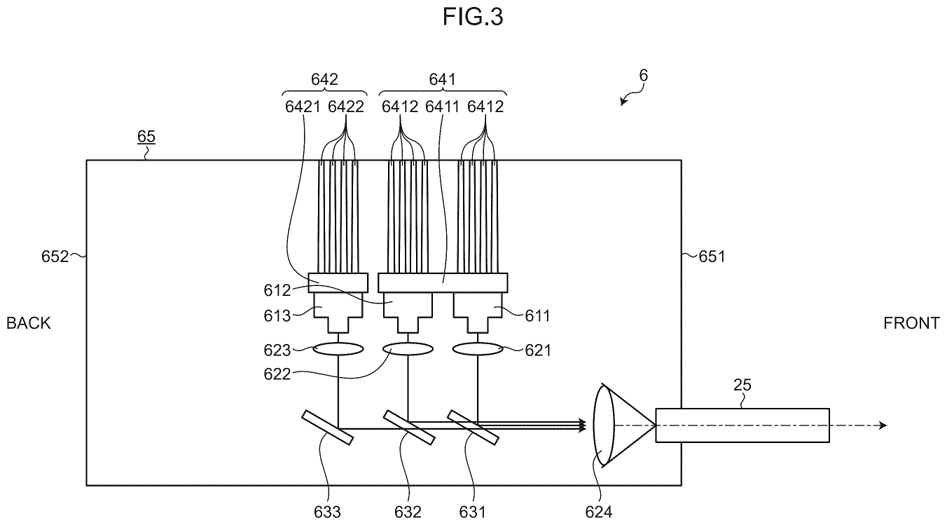

FIG. 3 is a diagram illustrating a modified example 1-1 of the first embodiment. Specifically, FIG. 3 is a diagram corresponding to FIG. 2 and illustrating a configuration of a light source device 6 according to the modified example 1-1.

In this modified example 1-1, illumination light emitted from the light source device 6 is different from that in the first embodiment described above. Specifically, the illumination light emitted from the light source device 6 according to this modified example 1-1 is white light with emphasis on brightness. Therefore, amounts of heat generated (W) by red, blue, and green light sources 611 to 613 according to this modified example 1-1 are different from those in the first embodiment described above.

The inventors of the present application took allowable heat resistances (K/W) into consideration in thermally connecting the blue light source 612 to one of first and second heat sinks 641 and 642 for a configuration according to the modified example 1-1.

Table 5 below corresponds to a case where the red, blue, and green light sources 611 to 613 are thermally connected to the same heat sink.

The maximum junction temperatures (° C.) and Ta (° C.) listed in Table 5 are the same as those listed in Table 1 to Table 4. The amounts of heat generated (W) by the red and blue light sources 611 and 612 according to the modified example 1-1 are the same as those in the first embodiment described above. However, the amount of heat generated by the green light source 613 according to the modified example 1-1 is 150 W for the white light to have emphasis on brightness. Because there is one heat sink, in Table 5, the amount of heat generated (W) is 180 W, which is the overall amount of heat generated (W) by the red, blue, and green light sources 611 to 613. Furthermore, ΔT (° C.), the allowable heat resistance (K/W), and the radiator volume (cc) listed in Table 5 are calculated by methods similar to those listed in Table 1 to Table 4.

TABLE 5

Red, green, and blue

| | | | |
|---|---|---|---|
| Maximum junction temperature (° C.) | 90 | 130 | 125 |

| | |
|---|---|
| Ta (° C.) | 25 |
| ΔT (° C.) | 65 |
| Amount of heat generated (W) | 180 |
| Allowable heat resistance (K/W) | 0.36 |
| Radiator volume (cc) | 2769 |

Table 6 below corresponds to a case where the red light source 611 is thermally connected to the first heat sink 641 and the blue and green light sources 612 and 613 are thermally connected to the second heat sink 642.

The maximum junction temperatures (° C.), Ta (° C.), and the amounts of heat generated (W) listed in Table 6 are the same as those listed in Table 5. Furthermore, ΔT (° C.), the allowable heat resistances (K/W), and the radiator volumes (cc) listed in Table 6 are calculated by methods similar to those listed in Table 5.

TABLE 6

| | Red | Green and blue | |
|---|---|---|---|
| Maximum junction temperature (° C.) | 90 | 130 | 125 |

| Ta (° C.) | 25 | |
|---|---|---|
| ΔT (° C.) | 65 | 100 |
| Amount of heat generated (W) | 20 | 160 |
| Allowable heat resistance (K/W) | 3.25 | 0.63 |
| Radiator volume (cc) | 308 | 1600 |

Table 7 below corresponds to a case where the red and green light sources 611 and 613 are thermally connected to the same heat sink and the blue light source 612 is thermally connected to another heat sink.

The maximum junction temperatures (° C.), Ta (° C.), and the amounts of heat generated (W) listed in Table 7 are the same as those listed in Table 5. Furthermore, ΔT (° C.), the allowable heat resistances (K/W), and the radiator volumes (cc) listed in Table 7 are calculated by methods similar to those listed in Table 5.

TABLE 7

| | Red and green | | Blue |
|---|---|---|---|
| Maximum junction temperature (° C.) | 90 | 130 | 125 |

| Ta (° C.) | 25 | |
|---|---|---|
| ΔT (° C.) | 65 | 100 |
| Amount of heat generated (W) | 170 | 10 |
| Allowable heat resistance (K/W) | 0.38 | 10 |
| Radiator volume (cc) | 2615 | 100 |

Table 8 below corresponds to a case where the red and blue light sources 611 and 612 are thermally connected to the first heat sink 641 and the green light source 613 is thermally connected to the second heat sink 642.

The maximum junction temperatures (C), Ta (° C.), and the amounts of heat generated (W) listed in Table 8 are the same as those listed in Table 5. Furthermore, ΔT (° C.), the allowable heat resistances (K/W), and the radiator volumes (cc) listed in Table 8 are calculated by methods similar to those listed in Table 5.

TABLE 8

| | Red and blue | | Green |
|---|---|---|---|
| Maximum junction temperature (° C.) | 90 | 125 | 130 |

| Ta (° C.) | 25 | |
|---|---|---|
| ΔT (° C.) | 65 | 105 |
| Amount of heat generated (W) | 30 | 150 |
| Allowable heat resistance (K/W) | 2.17 | 0.70 |
| Radiator volume (cc) | 462 | 1429 |

The radiator volume (cc) of the heat sink, 2769 cc (Table 5), in the case where the red, blue, and green light sources 611 to 613 are thermally connected to the same heat sink is regarded herein as 100%. By contrast, the overall radiator volume (cc) of the first and second heat sinks 641 and 642 in the case where the red light source 611 is thermally connected to the first heat sink 641 and the blue and green light sources 612 and 613 are thermally connected to the second heat sink 642 is 1908 cc (Table 6), which is 69%. Furthermore, the overall radiator volume (cc) of the heat sinks in the case where the red and green light sources 611 and 613 are thermally connected to the same heat sink and the blue light source 612 is thermally connected to another heat sink is 2715 cc (Table 7), which is 98%. The overall radiator volume (cc) of the first and second heat sinks 641 and 642 in the case where the red and blue light sources 611 and 612 are thermally connected to the first heat sink 641 and the green light source 613 is thermally connected to the second heat sink 642 is 1891 cc (Table 8), which is 68%.

In view of the above, the inventors of the present application thermally connected the red and blue light sources 611 and 612 to the first heat sink 641 and thermally connected the green light source 613 to the second heat sink 642, as illustrated in FIG. 3, so as to minimize the radiator volume (cc). In other words, the blue light source 612 is thermally connected to the first heat sink 641 shared with the red light source 611 that is one of the red and green light sources 611 and 613 and that forms a combination with the blue light source 612 resulting in a larger allowable heat resistance.

The modified example 1-1 described above has, in addition to effects similar to those of the first embodiment described above, the following effects.

In the light source device 6 according to this modified example 1-1, the blue light source 612 is thermally connected to the first heat sink 641 shared with the red light source 611 that is one of the red and green light sources 611 and 613 and that forms a combination with the blue light source 612 resulting in a larger allowable heat resistance.

Therefore, even in a case where white light with emphasis on brightness is used as illumination light, taking the allowable heat resistances into consideration enables, similarly to the first embodiment described above, reduction in manufacturing cost of the light source device 6 and overall downsizing of the heat sinks.

### Modified Example 1-2

In a modified example 1-2, red, blue, and green light sources 611 to 613 have maximum junction temperatures (° C.) different from those in the first embodiment described above.

The inventors of the present application took allowable heat resistances (K/W) into consideration in thermally connecting the blue light source 612 to one of first and second heat sinks 641 and 642 for a configuration according to the modified example 1-2.

Table 9 below corresponds to a case where the red, blue, and green light sources 611 to 613 are thermally connected to the same heat sink.

As listed in Table 9, the maximum junction temperature of the red light source 611 according to the modified example 1-2 is 90° C. (first temperature). The maximum junction temperature of the blue light source 612 according to the modified example 1-2 is 110° C. (second temperature). The maximum junction temperature of the green light source 613 according to the modified example 1-2 is 130° C. (third temperature). That is, in this modified example 1-2, a difference between the first and second temperatures and a difference between the second and third temperatures are the same at 20° C.

Furthermore, Ta (° C.) and the amount of heat generated (W) listed in Table 9 are the same as those listed in Table 1 to Table 4. Furthermore, ΔT (° C.), the allowable heat resistance (K/W), and the radiator volume (cc) listed in Table 9 are calculated by methods similar to those listed in Table 1 to Table 4.

TABLE 9

Red, green, and blue

| | | | |
|---|---|---|---|
| Maximum junction temperature (° C.) | 90 | 130 | 110 |

| | |
|---|---|
| Ta (° C.) | 25 |
| ΔT (° C.) | 65 |
| Amount of heat generated (W) | 60 |
| Allowable heat resistance (K/W) | 1.08 |
| Radiator volume (cc) | 923 |

Table 10 below corresponds to a case where the red light source 611 is thermally connected to the first heat sink 641 and the blue and green light sources 612 and 613 are thermally connected to the second heat sink 642.

The maximum junction temperatures (° C.), Ta (° C.), and the amounts of heat generated (W) listed in Table 10 are the same as those listed in Table 9. Furthermore, ΔT (° C.), the allowable heat resistances (K/W), and the radiator volumes (cc) listed in Table 10 are calculated by methods similar to those listed in Table 9.

TABLE 10

| | Red | Green and blue | |
|---|---|---|---|
| Maximum junction temperature (° C.) | 90 | 130 | 110 |

| Ta (° C.) | 25 | |
|---|---|---|
| ΔT (° C.) | 65 | 85 |
| Amount of heat generated (W) | 20 | 40 |
| Allowable heat resistance (K/W) | 3.25 | 2.13 |
| Radiator volume (cc) | 308 | 471 |

Table 11 below corresponds to a case where the red and green light sources 611 and 613 are thermally connected to the same heat sink and the blue light source 612 is thermally connected to another heat sink.

The maximum junction temperatures (° C.), Ta (° C.), and the amounts of heat generated (W) listed in Table 11 are the same as those listed in Table 9. Furthermore, ΔT (° C.), the allowable heat resistances (K/W), and the radiator volumes (cc) listed in Table 11 are calculated by methods similar to those listed in Table 9.

TABLE 11

| | Red and green | | Blue |
|---|---|---|---|
| Maximum junction temperature (° C.) | 90 | 130 | 110 |

| Ta (° C.) | 25 | |
|---|---|---|
| ΔT (° C.) | 65 | 85 |
| Amount of heat generated (W) | 50 | 10 |
| Allowable heat resistance (K/W) | 1.30 | 8.50 |
| Radiator volume (cc) | 769 | 118 |

Table 12 below corresponds to a case where the red and blue light sources 611 and 612 are thermally connected to the first heat sink 641 and the green light source 613 is thermally connected to the second heat sink 642.

The maximum junction temperatures (° C.), Ta (° C.), and the amounts of heat generated (W) listed in Table 12 are the same as those listed in Table 9. Furthermore, ΔT (° C.), the allowable heat resistances (K/W), and the radiator volumes (cc) listed in Table 12 are calculated by methods similar to those listed in Table 9.

TABLE 12

| | Red and blue | | Green |
|---|---|---|---|
| Maximum junction temperature (° C.) | 90 | 110 | 130 |

| Ta (° C.) | 25 | |
|---|---|---|
| ΔT (° C.) | 65 | 105 |
| Amount of heat generated (W) | 30 | 30 |
| Allowable heat resistance (K/W) | 2.17 | 3.50 |
| Radiator volume (cc) | 462 | 286 |

The radiator volume (cc) of the heat sink, 923 cc (Table 9), in the case where the red, blue, and green light sources 611 to 613 are thermally connected to the same heat sink is regarded herein as 100%. By contrast, the overall radiator volume (cc) of the first and second heat sinks 641 and 642 in the case where the red light source 611 is thermally connected to the first heat sink 641 and the blue and green light sources 612 and 613 are thermally connected to the second heat sink 642 is 779 cc (Table 10), which is 84%. Furthermore, the overall radiator volume (cc) of the heat sinks in the case where the red and green light sources 611 and 613 are thermally connected to the same heat sink and the blue light source 612 is thermally connected to another heat sink is 887 cc (Table 11), which is 96%. The overall radiator volume (cc) of the first and second heat sinks 641 and 642 in the case where the red and blue light sources 611 and 612 are thermally connected to the first heat sink 641 and the green light source 613 is thermally connected to the second heat sink 642 is 748 cc (Table 12), which is 81% (Table 12).

In view of the above, the inventors of the present application thermally connected the blue light source 612 to the first heat sink 641, similarly to the modified example 1-1 described above, so as to minimize the radiator volume (cc). In other words, the blue light source 612 is thermally connected to the first heat sink 641 shared with the red light source 611 that is one of the red and green light sources 611 and 613 and that forms a combination with the blue light source 612 resulting in a larger allowable heat resistance.

The modified example 1-2 described above has, in addition to effects similar to those of the first embodiment described above, the following effects.

In the light source device 6 according to the modified example 1-2, the difference between the maximum junction temperature of the blue light source 612 and the maximum junction temperature of the red light source 611 and the difference between the maximum junction temperature of the blue light source 612 and the maximum junction temperature of the green light source 613 are the same. In the light source device 6 according to this modified example 1-2, the blue light source 612 is thermally connected to the first heat sink 641 shared with the red light source 611 that is one of the red and green light sources 611 and 613 and that forms a combination with the blue light source 612 resulting in a larger allowable heat resistance.

Therefore, even if the difference between the maximum junction temperature of the blue light source 612 and the maximum junction temperature of the red light source 611 and the difference between the maximum junction temperature of the blue light source 612 and the maximum junction temperature of the green light source 613 are the same, taking the allowable heat resistances into consideration enables, similarly to the first embodiment described above, reduction in manufacturing cost of the light source device 6 and overall downsizing of the heat sinks.

### Modified Example 1-3

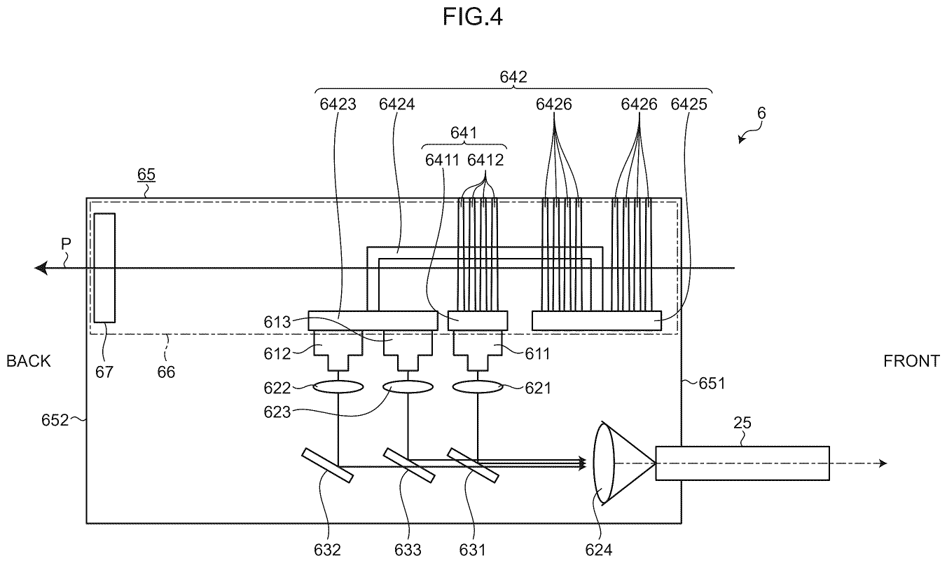

FIG. 4 is a diagram illustrating a modified example 1-3 of the first embodiment. Specifically, FIG. 4 is a diagram corresponding to FIG. 2 and illustrating a configuration of a light source device 6 according to the modified example 1-3.

In this modified example 1-3, as illustrated in FIG. 4, the configuration of the light source device 6 has been changed from that of the first embodiment described above.

The light source device 6 according to the modified example 1-3, as illustrate in FIG. 4, has: an exhaust duct 66 and a cooling fan 67, in addition to what the light source device 6 according to the first embodiment has; and a second heat sink 642 configured differently from that of the light source device 6 according to the first embodiment.

As illustrated in FIG. 4, the exhaust duct 66 is a duct that linearly extends, in a housing 65, from an intake (not illustrated in the drawings) formed in a side wall 651 at the front to a vent (not illustrated in the drawings) formed in a side wall 652 at the back, the duct forming a passage P for air flowing from the front to the back. First and second heat sinks 641 and 642 and the cooling fan 67 are arranged in the exhaust duct 66.

The cooling fan 67 is a fan that is arranged in the exhaust duct 66 and that allows air to flow along the passage P by being driven.

The second heat sink 642 according to the modified example 1-3 includes, as illustrated in FIG. 4, a heat receiver 6423, a heat pipe 6424, a diffusion portion 6425, and plural fins 6426.

As illustrated in FIG. 4, the heat receiver 6423 has blue and green light sources 612 and 613 thermally connected thereto and receives heat generated in the blue and green light sources 612 and 613.

As illustrated in FIG. 4, the heat pipe 6424 has one end connected to the heat receiver 6423 and transmits heat from the heat receiver 6423 from the one end to the other end of the heat pipe 6424.

As illustrated in FIG. 4, the other end of the heat pipe 6424 is connected to the diffusion portion 6425 and the diffusion portion 6425 diffuses the heat transmitted by the heat pipe 6424.

The plural fins 6426 radiate the heat from the heat receiver 6423 into the atmosphere, the heat having been transmitted to the diffusion portion 6425 via the heat pipe 6424.

In this modified example 1-3, the diffusion portion 6425 and the plural fins 6426, of the second heat sink 642 are arranged upstream of the first heat sink 641 in the passage P, as illustrated in FIG. 4. In other words, at least part of the second heat sink 642 is arranged upstream of the first heat sink 641 in the passage P, the second heat sink 642 being one of the first and second heat sinks 641 and 642, the one having light emitting elements (the blue and green light sources 612 and 613 having an allowable heat resistance of 2.50 K/W (Table 2)) thermally connected thereto, the light emitting elements having a smaller allowable heat resistance (K/W) than the other light emitting element (a red light source 611 having an allowable heat resistance of 3.25 K/W (Table 2)).

This modified example 1-3 described above has, in addition to effects similar to those of the first embodiment described above, the following effects.

In the light source device 6 according to the modified example 1-3, at least part of the second heat sink 642 is arranged upstream of the first heat sink 641 in the passage P, the second heat sink 642 being one of the first and second heat sinks 641 and 642, the one having the light emitting elements (the blue and green light sources 612 and 613 having the allowable heat resistance of 2.50 K/W (Table 2)) thermally connected thereto, the light emitting elements having the smaller allowable heat resistance (K/W) than the other light emitting element (the red light source 611 having the allowable heat resistance of 3.25 K/W (Table 2)).

Therefore, the second heat sink 642 having a smaller allowable heat resistance or, in other words, lower heat dissipation ability, is able to be cooled by air that is at the lowest temperature and the red, blue, and green light sources 611 to 613 are thus able to be cooled efficiently.

### Second Embodiment

A second embodiment will be described next.

In the following description, the same reference sign will be assigned to any component similar to that of the first embodiment described above, and detailed description thereof will be omitted or simplified.

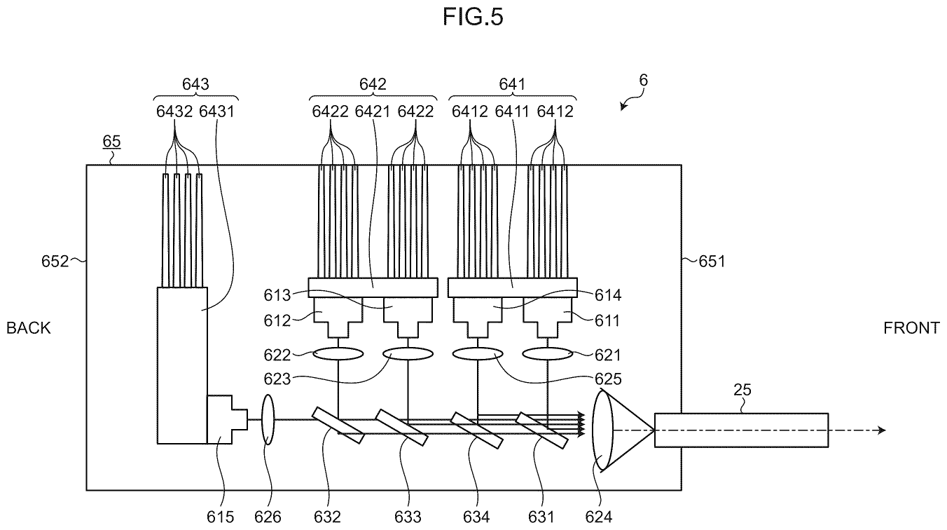

FIG. 5 is a diagram illustrating a configuration of a light source device 6 according to the second embodiment.

As illustrated in FIG. 5, the light source device 6 according to the second embodiment is configured differently from the light source device 6 according to the first embodiment described above.

### Configuration of Light Source Device

The light source device 6 according to the second embodiment has, in a housing 65, as illustrated in FIG. 5, amber and violet light sources 614 and 615, fifth and sixth lenses 625 and 626, a fourth dichroic mirror 634, and a third heat sink 643, in addition to what the light source device 6 according to the first embodiment described above has.

The amber light source 614 includes an LED or LD and emits amber light (for example, light in a wavelength band of about 590 to 610 nm). In this second embodiment, the amber light source 614 corresponds to a first light emitting element and a first heat generating element, and has a maximum junction temperature at a first temperature. A red light source 611 corresponds to a second light emitting element and a second heat generating element, and has a maximum junction temperature at a second temperature higher than the first temperature. Blue and green light sources 612 and 613 correspond to a third light emitting element and a third heat generating element, and have a maximum junction temperature at a third temperature higher than the second temperature.

The violet light source 615 includes an LED or LD and emits violet light (for example, light in a wavelength band of about 380 to 420 nm).

First to third dichroic mirrors 631 to 633 and the fourth dichroic mirror 634 bend the light from the red, blue, green, and amber light sources 611 to 614 to let the light travel on the same optical axis and let the violet light emitted from the violet light source 615 and condensed by the sixth lens 626 travel on that same optical axis.

Specifically, the first to third dichroic mirrors 631 to 633 have functions similar to those of the first embodiment described above. The fourth dichroic mirror 634 bends the amber light emitted from the amber light source 614 and condensed by the fifth lens 625 and transmits light in any other wavelength band therethrough, the light being other than the amber light.

The fourth lens 624 condenses illumination light (white light) that is a combination of red light, blue light, green light, the amber light, and the violet light coming via the first to fourth dichroic mirrors 631 to 634 and the fourth lens 624 guides the condensed illumination light to an other end of a light guide 25.

First and second heat sinks 641 and 642 and the third heat sink 643 radiate heat generated in the red, blue, green, amber, and violet light sources 611 to 615 into the atmosphere.

Specifically, the first heat sink 641 includes, as illustrated in FIG. 5: a heat receiver 6411 that is thermally connected to at least the amber light source 614 and receives at least the heat generated in the amber light source 614; and plural fins 6412 that radiate heat from the heat receiver 6411 into the atmosphere.

The second heat sink 642 includes, as illustrated in FIG. 5, a heat receiver 6421 that is thermally connected to the blue and green light sources 612 and 613 and receives the heat generated in the blue and green light sources 612 and 613, and plural fins 6422 that radiate heat from the heat receiver 6421 into the atmosphere.

The third heat sink 643 includes, as illustrated in FIG. 5: a heat receiver 6431 that is thermally connected to the violet light source 615 and receives the heat generated in the violet light source 615; and plural fins 6432 that radiate heat from the heat receiver 6431 into the atmosphere.

Connective relations between the first and second heat sinks 641 and 642 and the red light source 611 will be described in a section, “Connective Relations Between First and Second Heat Sinks and Red Light Source”, later.

### Connective Relations Between First and Second Heat Sinks and Red Light Source

The connective relations between the first and second heat sinks 641 and 642 and the red light source 611 will be described next.

In thermally connecting the red light source 611 to one of the first and second heat sinks 641 and 642, the inventors of the present application took maximum junction temperatures of the red, blue, green, and amber light sources 611 to 614 into consideration.

Table 13 below corresponds to a case where the red, blue, green, and amber light sources 611 to 614 are thermally connected to the same heat sink.

As listed in Table 13, the maximum junction temperature of the red light source 611 is 90° C. (second temperature). The maximum junction temperatures of the blue and green light sources 612 and 613 are both 130° C. (third temperature). The maximum junction temperature of the amber light source 614 is 80° C. (first temperature).

Furthermore, Ta (° C.) in Table 13 is the same as that in Table 1 to Table 4. The amount of heat generated (W) by the red light source 611 according to the second embodiment is 10 W. The amount of heat generated (W) by the blue light source 612 according to the second embodiment is 5 W. The amount of heat generated (W) by the green light source 613 according to the second embodiment is 40 W. The amount of heat generated (W) by the amber light source 614 according to the second embodiment is 30 W. Because there is one heat sink, in Table 13, the amount of heat generated (W) is 85 W, which is the overall amount of heat generated (W) by the red, blue, green, and amber light sources 611 to 614. Furthermore, ΔT (° C.), the allowable heat resistance (K/W), and the radiator volume (cc) listed in Table 13 are calculated by methods similar to those in Table 1 to Table 4.

TABLE 13

| | Red, amber, green, and blue | | | |
|---|---|---|---|---|
| Maximum junction temperature (° C.) | 90 | 80 | 130 | 130 |

| | |
|---|---|
| Ta (° C.) | 25 |
| ΔT (° C.) | 55 |
| Amount of heat generated (W) | 85 |
| Allowable heat resistance (K/W) | 0.65 |
| Radiator volume (cc) | 1545 |

Table 14 below corresponds to a case where the red and amber light sources 611 and 614 are thermally connected to the first heat sink 641 and the blue and green light sources 612 and 613 are thermally connected to the second heat sink 642.

The maximum junction temperatures (° C.), Ta (° C.), and the amounts of heat generated (W) listed in Table 14 are the same as those listed in Table 13. Furthermore, ΔT (° C.), the allowable heat resistances (K/W), and the radiator volumes (cc) listed in Table 14 are calculated by methods similar to those listed in Table 13.

TABLE 14

| | Red and amber | | Green and blue | |
|---|---|---|---|---|
| Maximum junction temperature (° C.) | 90 | 80 | 130 | 130 |

| Ta (° C.) | 25 | |
|---|---|---|
| ΔT (° C.) | 55 | 105 |
| Amount of heat generated (W) | 40 | 45 |
| Allowable heat resistance (K/W) | 1.38 | 2.33 |
| Radiator volume (cc) | 727 | 429 |

Table 15 below corresponds to a case where three heat sinks are used, the red light source 611 is thermally connected to a first one of the three heat sinks, the amber light source 614 and the green light source 613 are thermally connected to a second one of the three heat sinks, and the blue light source 612 is thermally connected to a third one of the three heat sinks.

The maximum junction temperatures (° C.), Ta (° C.), and the amounts of heat generated (W) listed in Table 15 are the same as those listed in Table 13. Furthermore, ΔT (° C.), the allowable heat resistances (K/W), and the radiator volumes (cc) listed in Table 15 are calculated by methods similar to those listed in Table 13.

TABLE 15

| | Red | Amber and green | | Blue |
|---|---|---|---|---|
| Maximum junction temperature | 90 | 80 | 130 | 130 |
| (° C.) | | | | |

| Ta (° C.) | 25 | | |
|---|---|---|---|
| ΔT (° C.) | 65 | 55 | 105 |
| Amount of heat generated (W) | 10 | 70 | 5 |
| Allowable heat resistance (K/W) | 6.50 | 0.79 | 21.00 |
| Radiator volume (cc) | 154 | 1273 | 48 |

The radiator volume (cc) of the heat sink, 1545 cc (Table 13), in the case where the red, blue, green, and amber light sources 611 to 614 are thermally connected to the same heat sink is regarded herein as 100%. By contrast, the overall radiator volume (cc) of the first and second heat sinks 641 and 642 in the case where the red and amber light sources 611 and 614 are thermally connected to the first heat sink 641 and the blue and green light sources 612 and 613 are thermally connected to the second heat sink 642 is 1156 cc (Table 14), which is 75%. The overall radiator volume (cc) of the heat sinks in the case where the three heat sinks are used, the red light source 611 is thermally connected to the first one of the three heat sinks, the amber light source 614 and the green light source 613 are thermally connected to the second one of the three heat sinks, and the blue light source 612 is thermally connected to the third one of the three heat sinks is 1474 cc (Table 15), which is 95%.

In view of the above, the inventors of the present application thermally connected the red and amber light sources 611 and 614 having the maximum junction temperatures that are close to each other to the first heat sink 641 and thermally connected the blue and green light sources 612 and 613 having the maximum junction temperatures that are close to each other to the second heat sink 642, so as to minimize the radiator volume (cc). In other words, the red light source 611 is thermally connected to the first heat sink 641 shared with the amber light source 614 that is one of the blue, green, and amber light sources 612 to 614, the one having the maximum junction temperature (first temperature) with a smaller difference from the second temperature.

Even if the above described configuration according to the second embodiment is adopted, effects similar to those of the first embodiment described above are achieved.

### Modified Example 2-1

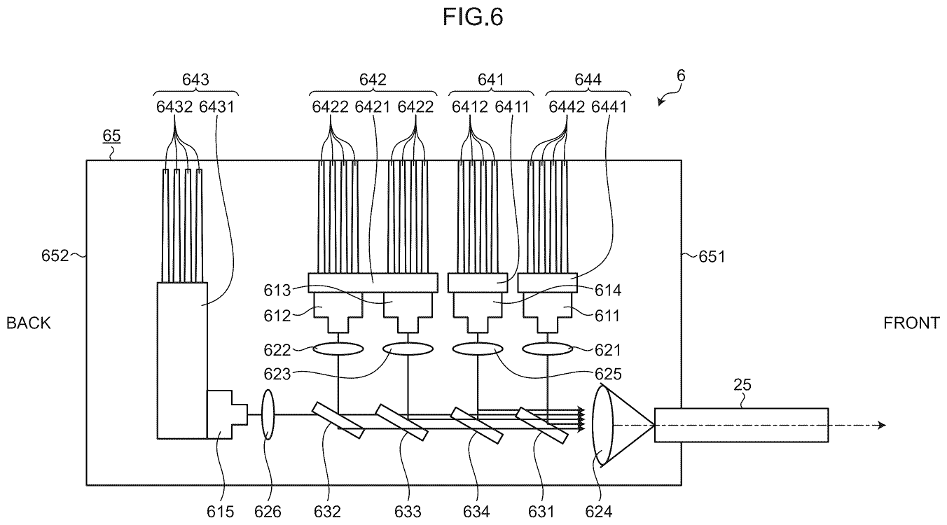

FIG. 6 is a diagram illustrating a modified example 2-1 of the second embodiment. Specifically, FIG. 6 is a diagram corresponding to FIG. 5 and illustrating a configuration of a light source device 6 according to the modified example 2-1.

In this modified example 2-1, the light source device 6 is configured in consideration of a special light observation mode. In the modified example 2-1, the special light observation mode is an observation mode where the interior of a living body is observed (red dichromatic imaging (RDI) observation) using illumination light that is a combination of red light, green light, and amber light. Therefore, in this modified example 2-1, values different from those of the second embodiment described above are considered as amounts of heat generated (W) by red, blue, green, and amber light sources 611 to 614.

For a configuration according to this modified example 2-1, the inventors of the present application took allowable heat resistances (K/W) into consideration in thermally connecting the red, blue, green, and amber light sources 611 to 614 to first and second heat sinks 641 and 642.

Table 16 below corresponds to a case where the red, blue, green, and amber light sources 611 to 614 are thermally connected to the same heat sink.

The maximum junction temperatures (C) and Ta (° C.) listed in Table 16 are the same as those listed in Table 13 to Table 15. The amount of heat generated (W) by the red light source 611 according to the modified example 2-1 is 300 W. The amount of heat generated (W) by the blue light source 612 according to the modified example 2-1 is 10 W. The amount of heat generated (W) by the green light source 613 according to the modified example 2-1 is 35 W. The amount of heat generated (W) by the amber light source 614 according to the modified example 2-1 is 300 W. Because there is one heat sink, in Table 16, the amount of heat generated (W) is 640 W, which is the overall amount of heat generated (W) by the red, blue, green, and amber light sources 611 to 614. Furthermore, ΔT (° C.), the allowable heat resistance (K/W), and the radiator volume (cc) listed in Table 16 are calculated by methods similar to those listed in Table 13 to Table 15.

TABLE 16

| | Red, amber, green, and blue | | | |
|---|---|---|---|---|
| Maximum junction temperature (° C.) | 90 | 80 | 130 | 130 |

| | |
|---|---|
| Ta (° C.) | 25 |
| ΔT (° C.) | 55 |
| Amount of heat generated (W) | 645 |
| Allowable heat resistance (K/W) | 0.09 |
| Radiator volume (cc) | 11727 |

Table 17 below corresponds to a case where the red and amber light sources 611 and 614 are thermally connected to the first heat sink 641 and the blue and green light sources 612 and 613 are thermally connected to the second heat sink 642, similarly to the second embodiment described above.

The maximum junction temperatures (° C.), Ta (° C.), and the amounts of heat generated (W) listed in Table 17 are the same as those listed in Table 16. Furthermore, ΔT (° C.), the allowable heat resistances (K/W), and the radiator volumes (cc) listed in Table 17 are calculated by methods similar to those listed in Table 16.

TABLE 17

| | Red and amber | | Green and blue | |
|---|---|---|---|---|
| Maximum junction temperature (° C.) | 90 | 80 | 130 | 130 |

| Ta (° C.) | 25 | |
|---|---|---|
| ΔT (° C.) | 55 | 105 |
| Amount of heat generated (W) | 600 | 45 |
| Allowable heat resistance (K/W) | 0.09 | 2.33 |
| Radiator volume (cc) | 10909 | 429 |

Table 18 below corresponds to a case where the first and second heat sinks 641 and 642 and a fourth heat sink 644 are used, the amber light source 614 is thermally connected to the first heat sink 641, the blue and green light sources are thermally connected to the second heat sink 642, and the red light source 611 is thermally connected to the fourth heat sink 644, as illustrated in FIG. 6.

The fourth heat sink 644 includes, as illustrated in FIG. 6: a heat receiver 6441 that is thermally connected to the amber light source 614 and receives the heat generated in the amber light source 614; and plural fins 6442 that radiate heat from the heat receiver 6441 into the atmosphere.

The maximum junction temperatures (° C.), Ta (° C.), and the amounts of heat generated (W) listed in Table 18 are the same as those listed in Table 16. Furthermore, ΔT (° C.), the allowable heat resistances (K/W), and the radiator volumes (cc) listed in Table 18 are calculated by methods similar to those listed in Table 16.

TABLE 18

| | Red | Amber | Green and blue | |
|---|---|---|---|---|
| Maximum junction temperature | 90 | 80 | 130 | 130 |
| (° C.) | | | | |

| Ta (° C.) | 25 | | |
|---|---|---|---|
| ΔT (° C.) | 65 | 55 | 105 |
| Amount of heat generated (W) | 300 | 300 | 45 |
| Allowable heat resistance (K/W) | 0.22 | 0.18 | 2.33 |
| Radiator volume (cc) | 4615 | 5455 | 429 |

The radiator volume (cc) of the heat sink, 11727 cc (Table 16), in the case where the red, blue, green, and amber light sources 611 to 614 are thermally connected to the same heat sink is regarded herein as 100%. By contrast, the overall radiator volume (cc) of the first and second heat sinks 641 and 642 in the case where the red and amber light sources 611 are thermally connected to the first heat sink 641 and the blue and green light sources 612 and 613 are thermally connected to the second heat sink 642 is 11338 cc (Table 17), which is 97%. Furthermore, the overall radiator volume (cc) of the first, second, and fourth heat sinks 641, 642, and 644 in the case where the amber light source 614 is thermally connected to the first heat sink 641, the blue and green light sources 612 and 613 are thermally connected to the second heat sink 642, and the red light source 611 is thermally connected to the fourth heat sink 644 is 10499 cc (Table 18), which is 90%.

In view of the above, the inventors of the present application thermally connected the amber light source 614 to the first heat sink 641, thermally connected the blue and green light sources 612 and 613 to the second heat sink 642, and thermally connected the red light source 611 to the fourth heat sink 644, so as to minimize the radiator volume (cc). In other words, for a configuration according to the second embodiment, the red and amber light sources 611 and 614 were thermally connected to separate heat sinks respectively because the allowable heat resistance (K/W) is at a comparatively small value (0.09 (Table 17)) in the case where the red and amber light sources 611 and 614 are thermally connected to the same heat sink.

This modified example 2-1 described above has, in addition to effects similar to those of the second embodiment described above, the following effects.

In the light source device 6 according to this modified example 2-1, the amber light source 614 is thermally connected to the first heat sink 641. The blue and green light sources 612 and 613 are thermally connected to the second heat sink 642. The red light source 611 is thermally connected to the fourth heat sink 644. The violet light source 615 is thermally connected to the third heat sink 643.

Therefore, even in a case where the observation mode for RDI observation is adopted, taking the allowable heat resistances into consideration enables, similarly to the second embodiment described above, reduction in manufacturing cost of the light source device 6 and overall downsizing of the heat sinks.

### Modified Example 2-2

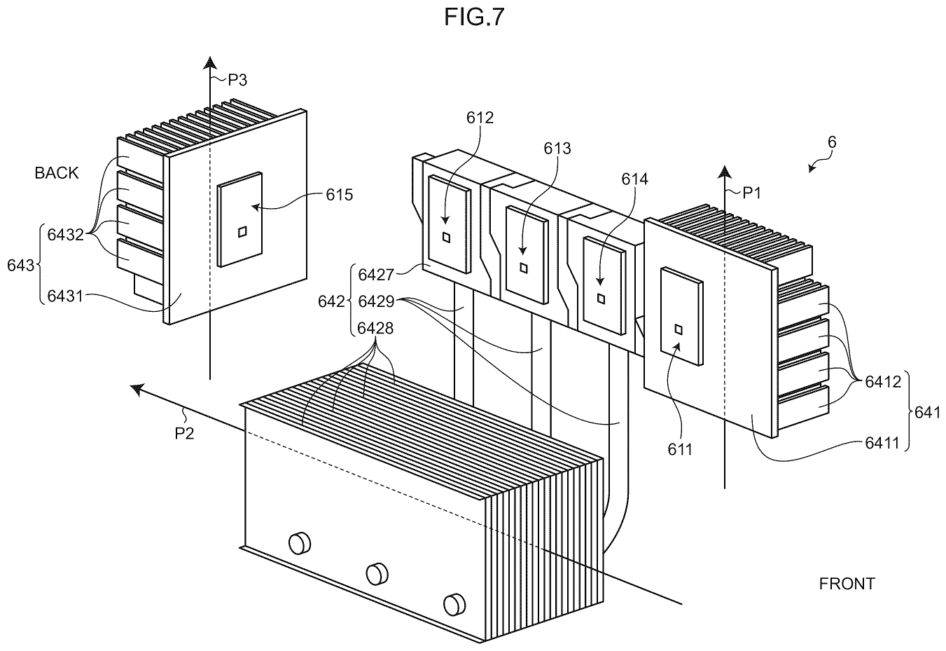

FIG. 7 is a diagram illustrating a modified example 2-2 of the second embodiment. Specifically, FIG. 7 is a diagram illustrating a configuration of a light source device 6 according to the modified example 2-2. For convenience of description, illustration of first to sixth lenses 621 to 626, first to fourth dichroic mirrors 631 to 634, and a housing 65 has been omitted in FIG. 7.

In this modified example 2-2, as illustrated in FIG. 7, a configuration of first to third heat sinks 641 to 643 of the light source device 6 has been changed from that of the light source device 6 according to the second embodiment described above.

The first heat sink 641 includes, as illustrated in FIG. 7: a heat receiver 6411 that is thermally connected to a red light source 611 and receives the heat generated in the red light source 611; and plural fins 6412 that radiate heat from the heat receiver 6411 into the atmosphere. That is, in this modified example 2-2, the red light source 611 corresponds to a first light emitting element and a first heat generating element.

The plural fins 6412 each extend from the bottom to the top, as illustrated in FIG. 7. The plural fins 6412 exchange heat with air naturally convected along a passage P1 from the bottom to the top and radiate the heat from the heat receiver 6411 into the atmosphere.

The second heat sink 642 includes, as illustrated in FIG. 7, a heat receiver 6427, plural fins 6428, and plural heat pipes 6429.

The heat receiver 6427 is thermally connected to blue, green, and amber light sources 612 to 614 and receives heat generated in the blue, green, and amber light sources 612 to 614. That is, in this modified example 2-2, the blue, green, and amber light sources 612 to 614 correspond to a second light emitting element (second heat generating element) and a third light emitting element (third heat generating element).

The plural heat pipes 6429 each have one end connected to the heat receiver 6427 and each transmit heat from the heat receiver 6427 from the one end to the other end thereof.

As illustrated in FIG. 7, the plural fins 6428 each extend from the front where a side wall 651 is positioned, to the back where the side wall 652 is positioned. Furthermore, each of the other ends of the plural heat pipes 6429 are connected to the plural fins 6428. The plural fins 6428 exchange heat with air forcibly passed along a passage P2 from the front to the back and radiate the heat from the heat receiver 6427 into the atmosphere, the heat having been transmitted via the plural heat pipes 6429.

The third heat sink 643 includes, as illustrated in FIG. 7: a heat receiver 6431 that is thermally connected to the violet light source 615 and receives the heat generated in the violet light source 615; and plural fins 6432 that radiate heat from the heat receiver 6431 into the atmosphere.

The plural fins 6432 each extend from the bottom to the top, as illustrated in FIG. 7. The plural fins 6412 exchange heat with air naturally convected along a passage P3 from the bottom to the top and radiate the heat from the heat receiver 6411 into the atmosphere.

Table 19 below corresponds to a case where the red light source 611 is thermally connected to the first heat sink 641, the blue, green, and amber light sources 612 to 614 are thermally connected to the second heat sink 642, and the violet light source 615 is thermally connected to the third heat sink 643, as illustrated in FIG. 7.

As listed in Table 19, the maximum junction temperature of the red light source 611 is 90° C. (first temperature). The maximum junction temperatures of the blue, green, amber, and violet light sources 612 to 615 are each 130° C. (second and third temperatures).

Furthermore, Ta (° C.) in Table 19 is the same as that in Table 13 to Table 15. The amount of heat generated (W) by the red light source 611 according to this modified example 2-2 is 30 W. The amount of heat generated (W) by the amber light source 614 according to this modified example 2-2 is 25 W. The amount of heat generated (W) by the green light source 613 according to this modified example 2-2 is 70 W. The amount of heat generated (W) by the blue light source 612 according to this modified example 2-2 is 10 W. The amount of heat generated (W) by the violet light source 615 according to this modified example 2-2 is 30 W. As listed in Table 19, because the blue, green, and amber light sources 612 to 614 are thermally connected to the second heat sink 642, the amount of heat generated (W) corresponding to the second heat sink 642 is 105 W, which is the overall amount of heat generated (W) by the blue, green, and amber light sources 612 to 614. Furthermore, ΔT (° C.), the allowable heat resistances (K/W), and the radiator volumes (cc) listed in Table 19 are calculated by methods similar to those listed in Table 13 to Table 15.

TABLE 19

| | | Amber, green, | | | |
|---|---|---|---|---|---|
| | Red | and blue | | | Violet |
| Maximum junction temperature | 90 | 130 | 130 | 130 | 130 |
| (° C.) | | | | | |

| Ta (° C.) | 25 | | |
|---|---|---|---|
| ΔT (° C.) | 65 | 105 | 105 |
| Amount of heat generated (W) | 30 | 105 | 30 |
| Allowable heat resistance (K/W) | 2.17 | 1 | 3.50 |
| Radiator volume (cc) | 462 | 1000 | 286 |

This modified example 2-2 described above has, in addition to effects similar to those of the second embodiment described above, the following effects.

In the light source device 6 according to this modified example 2-2, the first to third heat sinks 641 to 643 are respectively arranged on the passages P1 to P3 different from one another. In particular, the second heat sink 642 smaller in allowable heat resistance implements forced air cooling and the first and third heat sinks 641 and 643 larger in allowable heat resistance implement natural air cooling.

Therefore, the red, blue, green, amber, and violet light sources 611 to 615 are able to be cooled efficiently. Furthermore, general purpose heat sinks are able to be used as the first and third heat sinks 641 and 643 larger in allowable heat resistance and the cost of the first and third heat sinks 641 and 643 is thus able to be reduced.

### Modified Example 2-3

Red, blue, green, amber, and violet light sources 611 to 615 will hereinafter be referred to as a light source 61.

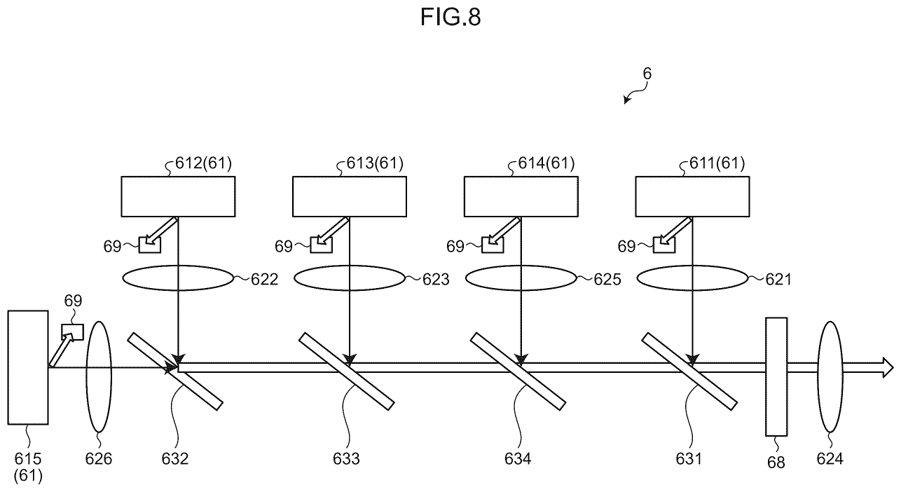

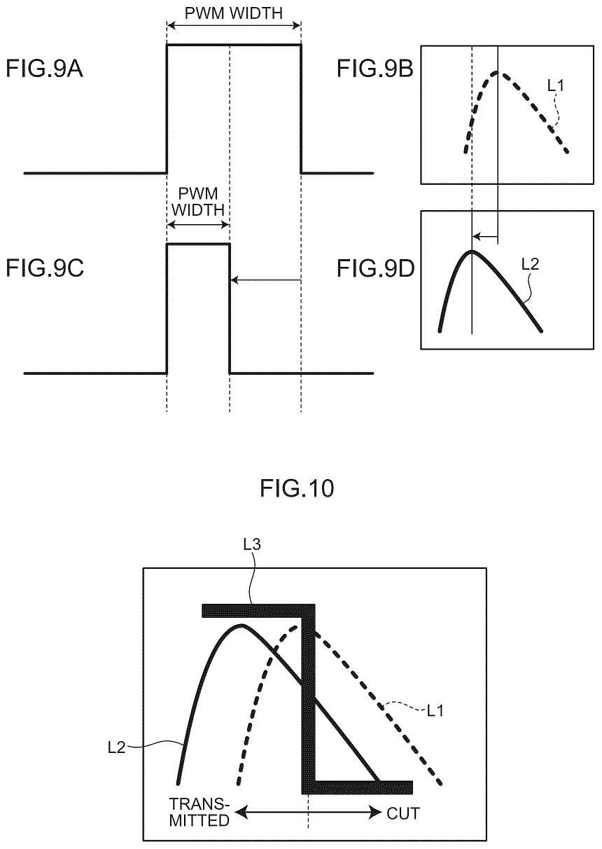

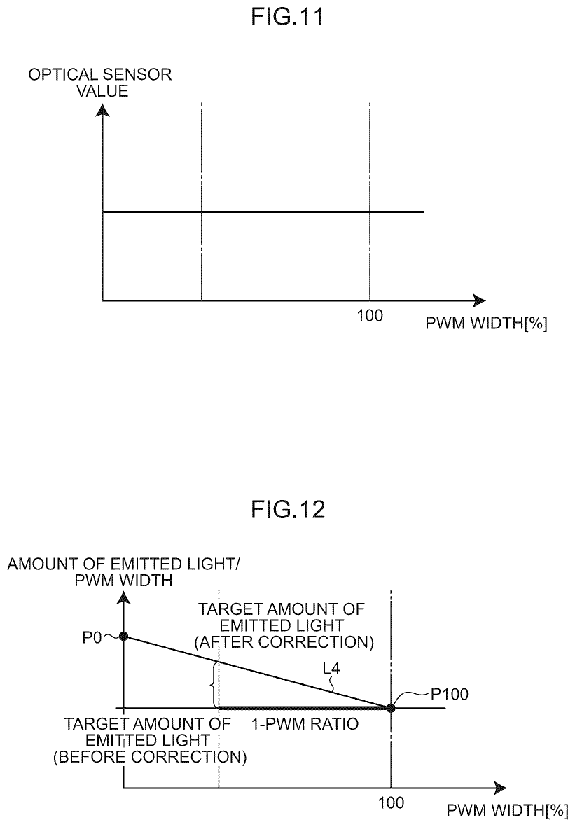

FIG. 8 to FIG. 12 are diagrams illustrating a modified example 2-3 of the second embodiment. Specifically, FIG. 8 is a diagram corresponding to FIG. 5 and illustrating a configuration of a light source device 6 according to this modified example 2-3. For convenience of description, illustration of first to third heat sinks 641 to 643 and a housing 65 has been omitted in FIG. 8. FIGS. 9A to 9D are diagrams illustrating a wavelength shift of light emitted from the light source 61. FIG. 9A is a diagram with the horizontal axis representing time and the vertical axis representing the value of electric current supplied to the light source 61. FIG. 9B is a diagram illustrating wavelength characteristics of light emitted from the light source 61 in a case where electric current illustrated by FIG. 9A is supplied to the light source 61. FIG. 9C is a diagram corresponding to FIG. 9A. FIG. 9D is a diagram illustrating wavelength characteristics of light emitted from the light source 61 in a case where electric current illustrated by FIG. 9C is supplied to the light source 61. FIG. 10 is a diagram for comparison between the wavelength characteristics of the light emitted from the light source 61 and transmission characteristics of a filter 68. FIG. 11 is a diagram illustrating the output value (hereinafter, referred to as the optical sensor value) from an optical sensor 69, with the horizontal axis representing the applied pulse width (PWM width) (%) of the electric current supplied to the light source 61 and the vertical axis representing the optical sensor value. FIG. 12 is a diagram illustrating the value (the amount of emitted light/PWM width) resulting from division of the amount of emitted light emitted from the light source device 6 by the PWM width, with the horizontal axis representing the PWM width (%) and the vertical axis representing the amount of emitted light/PWM width.

The light source device 6 according to this modified example 2-3 has, as illustrated in FIG. 8, the filter 68 and the optical sensor 69, in addition to what the light source device 6 according to the second embodiment described above has.

The filter 68 is a filter for special light observation, such as narrow band imaging (NBI). The filter 68 removes (cuts) light in a specific wavelength band, from light coming via first to third dichroic mirrors 631 to 633 and transmits light in any other wavelength band therethrough.

The optical sensor 69 is arranged near the light source 61 and detects light emitted from the light source 61, as illustrated in FIG. 8. The optical sensor 69 outputs an optical sensor value detected, to a control unit 51.

On the basis of the optical sensor value, the control unit 51 controls operation of the light source device 6 (light adjustment control). Specifically, a storage unit 52 stores relative information indicating a relation between the optical sensor value and the amount of emitted light emitted from the light source device 6. The control unit 51 refers to the relative information, recognizes a targeted optical sensor value (hereinafter, referred to as a target optical sensor value) corresponding to a targeted amount of emitted light (hereinafter, referred to as a target amount of emitted light), and determines driving current (hereinafter, referred to as light source driving current) to be supplied to the light source 61 so that the optical sensor value becomes the target optical sensor value.

The control unit 51 adjusts light by changing the PWM width while controlling the light source driving current so that the optical sensor value becomes constant in a specific PWM light adjustment range.

In a case where the PWM width has changed, the temperature of the light source 61 changes. As a result, as illustrated in FIGS. 9A to 9D, the wavelength shift of the light emitted from the light source 61 occurs. In FIGS. 9A to 9D, the wavelength characteristic of the light emitted from the light source 61 in a case where the electric current comparatively large in PWM width illustrated by FIG. 9A is supplied to the light source 61 are illustrated by a curve L1 (FIG. 9B). Furthermore, the wavelength characteristics of the light emitted from the light source 61 in a case where the electric current comparatively small in PWM width illustrated by FIG. 9C is supplied to the light source 61 are illustrated by a curve L2 (FIG. 9D). FIGS. 9A to 9D illustrate a pattern, in which the smaller the PWM width is, the lower the wavelength is shifted.

When a wavelength shift occurs in a case where the PWM width is changed like in the example illustrated in FIGS. 9A to 9D, the amount of light cut by the filter 68 changes as illustrated in FIG. 10 and the amount of emitted light emitted from the light source device 6 is thus changed. In the example illustrated in FIG. 10, the transmission characteristics of the filter 68 are represented by a curve L3. Similarly, the amount of emitted light emitted from the light source device 6 is changed when a wavelength shift occurs in the case where the PWM width is changed like in the example of FIGS. 9A to 9D, due to, not only those of the filter 68, but also transmission characteristics of the first to third dichroic mirrors 631 to 633 and a fourth dichroic mirror 634.

That is, although the optical sensor value is constant, due to the influence of the wavelength shift associated with the change in the PWM width, the amount of emitted light emitted from the light source device 6 is changed. Unless the difference in the relation between the optical sensor value and the amount of emitted light emitted from the light source device 6 is corrected, the difference being generated when the PWM width changes, the correct light source driving current is unable to be determined in the specific PWM light adjustment range.

Therefore, PWM_DIFF, which is a coefficient for correcting the difference generated when the PWM width changes, is calculated as follows, the difference being in the relation between the optical sensor value and the amount of emitted light emitted from the light source device 6.

As illustrated in FIG. 11, the light source driving current is controlled so that the optical sensor value remains constant even if the PWM width is changed. The amount of emitted light emitted from the light source device 6 when the PWM width is changed is measured at several points, these amounts of emitted light measured at the several points are divided by the corresponding PWM widths respectively, and several measured points for the amount of emitted light/PWM width are acquired in relation to the PWM widths. An approximate straight line is then calculated from these several measured points. In the example illustrated in FIG. 12, the approximate straight line calculated is illustrated by a straight line L4. The gradient of the straight line L4 is calculated as PWM_DIFF by Equation 1 below.

$$PWM\_DIFF = ( Amount of emitted light at PWM width of 0 \% / PWM width - Amount of emitted light at PWM width of 100 \% / PWM width ) / Amount of emitted light at PWM width of 100 \% / PWM width \qquad ( 1 )$$

In Equation 1, “amount of emitted light at PWM width of 0%” corresponds to the amount of emitted light at the PWM width of 0%/a PWM width P0 derived from the straight line L4, as illustrated in FIG. 12. Furthermore, “amount of emitted light at PWM width of 100%/PWM width” corresponds to the amount of emitted light at the PWM width of 100%/a PWM width P100, derived from the straight line L4.

The control unit 51 then corrects the target amount of emitted light by using PWM_DIFF and Equation 2 below. Furthermore, the control unit 51 refers to the relative information stored in the storage unit 52, recognizes the target optical sensor value corresponding to the corrected target amount of emitted light, and determines the light source driving current so that the optical sensor value becomes the corrected target optical sensor value.

$$Target amount of emitted light ( after correction ) = Target amount of emitted light \text{} ( before correction ) \times [ 1 + PWM\_DIFF \times ( 1 - PWM ratio ) ] \qquad ( 2 )$$

For example, in Equation 2, in a case where the PWM width is 40%, “target amount of emitted light (after correction” is the target amount of emitted light (before correction)+PWM_DIFF×60%×the target amount of emitted light (before correction). In a case where the PWM width is 100%, no correction is required.

The modified example 2-3 described above has, in addition to effects similar to those of the second embodiment described above, the following effects.

In this modified example 2-3, the control unit 51 corrects the target amount of emitted light by using Equation 2, and is thus able to determine the correct light source driving current in the specific PWM light adjustment range, and is thus able to correctly adjust the light even in a case where a wavelength shift in the light emitted from the light source 61 occurs.

### Other Embodiments

Modes for implementing the disclosure have been described thus far, but the disclosure is not to be limited to only the first and second embodiments and modified examples 1-1 to 1-3 and 2-1 to 2-3 described above.

Any electronic component mounted on a circuit board, for example, may be adopted as a heat generating element without the heat generating element being limited to the light emitting elements described above with respect to the first and second embodiments and modified examples 1-1 to 1-3 and 2-1 to 2-3.

In the above described first and second embodiments and modified examples 1-1 to 1-3 and 2-1 to 2-3, the light source devices are each installed in the endoscope system 1 using a flexible endoscope, but without being limited to these embodiments and modified examples, a light source device may be installed in an endoscope system using a rigid endoscope. Furthermore, a light source device may be installed in an observation system using a surgical microscope for capturing an enlarged image of a predetermined field of view inside a subject (inside a living body) or on a surface of a subject (a surface of a living body).

A light source device and a cooling unit, according to the disclosure enable reduction in manufacturing cost and downsizing.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A light source device, comprising:
a first light emitting element having a maximum junction temperature at a first temperature;
a second light emitting element having a maximum junction temperature at a second temperature higher than the first temperature;
a third light emitting element having a maximum junction temperature at a third temperature equal to or higher than the second temperature;
a first heat sink to which the first light emitting element is thermally connected; and
a second heat sink to which the third light emitting element is thermally connected, wherein
the second light emitting element is thermally connected to a heat sink shared with a light emitting element that is one of the first light emitting element and the third light emitting element and that forms a combination with the second light emitting element resulting in a larger allowable heat resistance of a radiator, the allowable heat resistance being calculated from: a difference between a maximum junction temperature and an ambient temperature; and an amount of heat generated.

2. The light source device according to claim 1, wherein the second light emitting element is thermally connected to a heat sink shared with a light emitting element that is one of the first light emitting element and the third light emitting element and that has a maximum junction temperature with a smaller difference from the second temperature.

3. The light source device according to claim 1, wherein the first heat sink and the second heat sink are respectively arranged on passages different from each other.

4. The light source device according to claim 1, wherein
the first heat sink and the second heat sink are arranged on the same passage, and
at least part of one of the first heat sink and the second heat sink is arranged upstream of another one of the first heat sink and the second heat sink in the passage, the one being thermally connected to a light emitting element having a smaller allowable heat resistance of the radiator than another light emitting elements.

5. A cooling unit, comprising:
a first heat generating element having a maximum junction temperature at a first temperature;
a second heat generating element having a maximum junction temperature at a second temperature higher than the first temperature;
a third heat generating element having a maximum junction temperature at a third temperature equal to or higher than the second temperature;
a first heat sink to which the first heat generating element is thermally connected; and
a second heat sink to which the third heat generating element is thermally connected, wherein
the second heat generating element is thermally connected to a heat sink shared with a heat generating element that is one of the first heat generating element and the third heat generating element and that forms a combination with the second heat generating element resulting in a larger allowable heat resistance of a radiator, the allowable heat resistance being calculated from: a difference between a maximum junction temperature and an ambient temperature; and an amount of heat generated.

6. The light source device according to claim 1, wherein the first light emitting element is configured to emit red light.

7. The light source device according to claim 1, wherein the second light emitting element is configured to emit blue light.

8. The light source device according to claim 1, wherein the third light emitting element is configured to emit green light.

9. The light source device according to claim 1, wherein
the first heat sink comprises:
a first heat receiver to which the first light emitting element is thermally connected, the first heat receiver being configured to receive heat generated in the first light emitting element; and
plural first fins configured to radiate the heat of the first heat receiver into atmosphere, and
the second heat sink comprises:
a second heat receiver to which the second light emitting element and the third light emitting element are thermally connected, the second heat receiver being configured to receive heat generated in the second light emitting element and the third light emitting element; and
plural second fins configured to radiate the heat of the second heat receiver into the atmosphere.

10. The light source device according to claim 1, wherein the second light emitting element and the third light emitting element are positioned by the second heat sink.

11. The light source device according to claim 1, wherein
the first light emitting element is an amber light source configured to emit amber light,
the second light emitting element is a red light source configured to emit red light,
the third light emitting element is a blue light source configured to emit blue light,
the amber light source that is the first light emitting element is thermally connected to the first heat sink,
the blue light source that is the third light emitting element is thermally connected to the second heat sink, and
the second light emitting element is thermally connected to the first heat sink.

12. The light source device according to claim 11, further comprising:
a fourth light emitting element that is a green light source configured to emit green light, wherein
the fourth light emitting element is thermally connected to the second heat sink.

13. The light source device according to claim 12, further comprising:
a fifth light emitting element that is a violet light source configured to emit violet light; and
a third heat sink, wherein
the fifth light emitting element is thermally connected to the third heat sink.

14. The light source device according to claim 1, further comprising:
a third heat sink and a fourth heat sink, wherein
the first heat sink is thermally connected to an amber light source serving as the first light emitting element,
the second heat sink is thermally connected to a blue light source serving as the second light emitting element and a green light source serving as the third light emitting element,
the third heat sink is thermally connected to a violet light source serving as a fourth light emitting element, and
the fourth heat sink is thermally connected to a red light source serving as a fifth light emitting element.

15. The light source device according to claim 14, wherein the light source device has a mode where the light source device emits illumination light that is a combination of red light, green light, and amber light.

16. The light source device according to claim 1, further comprising:
a third heat sink, wherein
a red light source serving as the first light emitting element is thermally connected to the first heat sink,
blue, green, and amber light sources serving as the second light emitting element are thermally connected to the second heat sink, and
a violet light source serving as the third light emitting element is thermally connected to the third heat sink.

17. The light source device according to claim 16, wherein the first heat sink, the second heat sink, and the third heat sink are respectively arranged on passages different from one another.

18. The light source device according to claim 17, wherein the second heat sink has an allowable heat resistance smaller than allowable heat resistances of the first heat sink and the third heat sink.

19. The light source device according to claim 18, wherein the second heat sink is configured to radiate heat by forced air cooling.

20. The light source device according to claim 19, wherein the first heat sink and the third heat sink are configured to radiate heat by natural air cooling.
